(19) United States
(12) Patent Application Publication
(10) Pub. No.: US 2021/0396978 A1
(43) Pub. Date: Dec. 23, 2021

(54) OBSERVATION OPTICAL SYSTEM AND IMAGE DISPLAY APPARATUS

(71) Applicant: SONY GROUP CORPORATION, TOKYO (JP)

(72) Inventors: SUSUMU ICHIKAWA, TOKYO (JP); TAKATOSHI MATSUYAMA, TOKYO (JP); MASATOSHI NAKAMURA, TOKYO (JP); MAMORU SUZUKI, TOKYO (JP); MITSUHARU MATSUMOTO, TOKYO (JP)

(21) Appl. No.: 17/290,121

(22) PCT Filed: Oct. 18, 2019
(86) PCT No.: PCT/JP2019/041041

§ 371 Date: Apr. 29, 2021

(30) Foreign Application Priority Data
Nov. 9, 2018 (JP) 2018-211711
Mar. 14, 2019 (JP) 2019-047459

(51) Int. Cl. G02B 17/08; G02B 13/18; G02B 27/01

(52) U.S. Cl. CPC G02B 17/08; G02B 13/18; G02B 2027/011; G02B 2027/0123; G02B 27/0172

(57) ABSTRACT

An observation optical system according to the present invention includes a reflective optical device (30), a first lens group (10), and a second lens group (20). The reflective optical device (30) includes at least one reflection surface (31). The first lens group (10) is disposed at a position closer to an entrance pupil (E.P.) than the reflective optical device (30). The first lens group (10) forms an intermediate image (40) of a virtual image on the reflection surface (31) or at a position closer to the entrance pupil (E.P.) than the reflection surface (31). The intermediate image (40) of the virtual image corresponds to an image displayed on an image display unit (2). The second lens group (20) is disposed on an optical path after light passes through the first lens group (10), the intermediate image (40), and the reflective optical device (30) in order in a case where ray tracing is performed from an entrance pupil (E.P.) side. The second lens group (20) is disposed to cause an image (50) of the entrance pupil (E.P.) to be formed on an optical path after light is reflected by the reflection surface (31).

### TECHNICAL FIELD

The present disclosure relates to an observation optical system and an image display apparatus that are suitable for a head mounted display (HMD) or the like.

### BACKGROUND ART

As an image display apparatus, a head mounted display is known (for example, see PTLs 1 to 5).

### CITATION LIST

### Patent Literature

PTL 1: Japanese Unexamined Patent Application Publication No. 2017-211474

PTL 2: Japanese Unexamined Patent Application Publication No. 2018-106167

PTL 3: Japanese Unexamined Patent Application Publication No. H10-153748

PTL 4: Japanese Unexamined Patent Application Publication No. 2004-341411

PTL 5: Japanese Unexamined Patent Application Publication No. 2013-25102

### SUMMARY OF THE INVENTION

A head mounted display is used for a long time while a display apparatus body is worn in front of one's eyes. Therefore, it may be required that an observation optical system and a display apparatus body be small in size and light in weight. In addition, it may be also required that it is possible to observe an image at a wide viewing angle.

It is desirable to provide an observation optical system and an image display apparatus that make it possible to achieve both an increase in viewing angle and a reduction in size and weight.

An observation optical system according to an embodiment of the present disclosure includes a reflective optical device, a first lens group, and a second lens group. The reflective optical device includes at least one reflection surface. The first lens group is disposed at a position closer to an entrance pupil than the reflective optical device. The first lens group forms an intermediate image of a virtual image on the reflection surface or at a position closer to the entrance pupil than the reflection surface. The intermediate image of the virtual image corresponds to an image displayed on an image display unit. The second lens group is disposed on an optical path after light passes through the first lens group, the intermediate image, and the reflective optical device in order in a case where ray tracing is performed from an entrance pupil side. The second lens group is disposed to cause an image of the entrance pupil to be formed on an optical path after light is reflected by the reflection surface.

An image display apparatus according to an embodiment of the present disclosure includes an image display unit and an observation optical system. The observation optical system enlarges an image displayed on the image display unit. The observation optical system includes a reflective optical device, a first lens group, and a second lens group. The reflective optical device includes at least one reflection surface. The first lens group is disposed at a position closer to an entrance pupil than the reflective optical device. The first lens group forms an intermediate image of a virtual image on the reflection surface or at a position closer to the entrance pupil than the reflection surface. The intermediate image of the virtual image corresponds to an image displayed on the image display unit. The second lens group is disposed on an optical path after light passes through the first lens group, the intermediate image, and the reflective optical device in order in a case where ray tracing is performed from an entrance pupil side. The second lens group is disposed to cause an image of the entrance pupil to be formed on an optical path after light is reflected by the reflection surface.

In the observation optical system or the image display apparatus according to the embodiment of the present disclosure, the first lens group is disposed at the position closer to the entrance pupil than the reflective optical device, and forms the intermediate image of the virtual image on the reflection surface or at the position closer to the entrance pupil than the reflection surface. The intermediate image of the virtual image corresponds to the image displayed on the image display unit. The second lens group is disposed on the optical path after light passes through the first lens group, the intermediate image, and the reflective optical device in order in the case where ray tracing is performed from the entrance pupil side, and causes the image of the entrance pupil to be formed on the optical path after light is reflected by the reflection surface.

### BRIEF DESCRIPTION OF THE DRAWINGS

FIG. 1 is a configuration diagram illustrating an example of a state where an image display apparatus using an observation optical system according to an embodiment of the present disclosure is mounted on a viewer's head.

FIG. 2 is an explanatory diagram illustrating an example of a state of reflected light in the observation optical system using a plane mirror at an inclination angle of 0 degree.

FIG. 3 is an explanatory diagram illustrating an example of a state of reflected light in the observation optical system using the plane mirror at an inclination angle of 15 degrees.

FIG. 4 is an explanatory diagram illustrating an example of a state of reflected light in the observation optical system using an elliptical mirror.

FIG. 5 is a schematic optical system cross-sectional view of a configuration example of the observation optical system and the image display apparatus according to the embodiment of the present disclosure.

FIG. 6 is a schematic optical system cross-sectional view of a configuration example of an observation optical system and an image display apparatus according to a first comparative example.

FIG. 7 is a schematic optical system cross-sectional view of a configuration example of an observation optical system and an image display apparatus according to a second comparative example.

FIG. 8 is a schematic optical system cross-sectional view of a first modification of the observation optical system and the image display apparatus according to the embodiment.

FIG. 9 is a schematic optical system cross-sectional view of a second modification of the observation optical system and the image display apparatus according to the embodiment.

FIG. 10 is an optical system cross-sectional view of a configuration of an observation optical system and an image display apparatus according to Example 1.

FIG. 11 is an optical system cross-sectional view of a configuration of an observation optical system and an image display apparatus according to Example 2.

FIG. 12 is an optical system cross-sectional view of a configuration of an observation optical system and an image display apparatus according to Example 3.

### MODES FOR CARRYING OUT THE INVENTION

Hereinafter, embodiments of the present disclosure are described in detail with reference to the drawings. Note that the description will be given in the following order.

0. Comparative Example

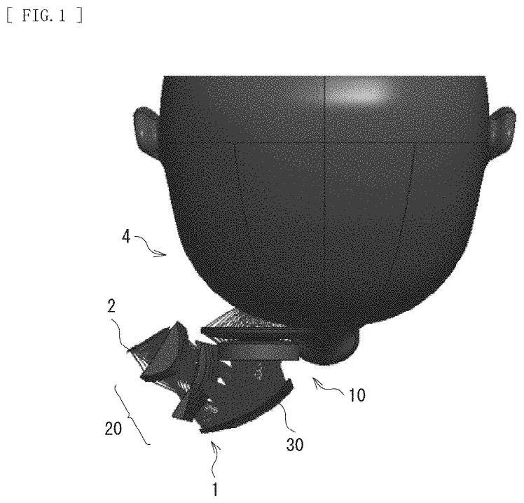

1. Overview (FIGS. 1 to 9)
1.1 Overview of Observation Optical System and Image Display Apparatus According to Embodiment of Present Disclosure
1.2 Effects and Modifications

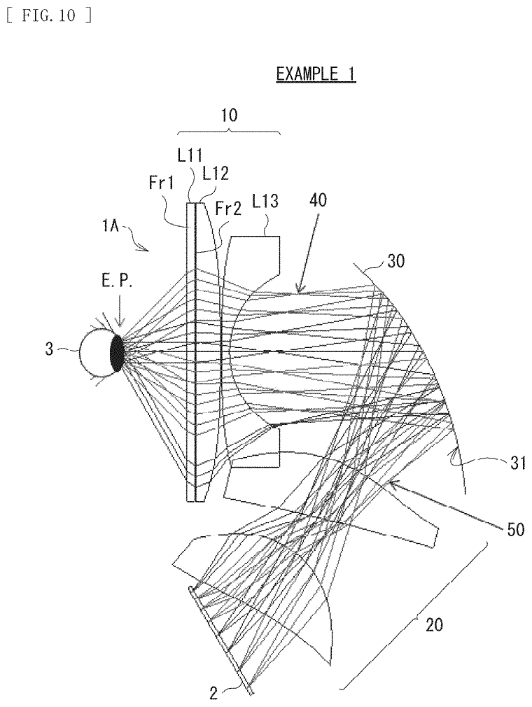

2. Numerical Examples of Optical System (FIGS. 10 to 12)

3. Other Embodiments

### 0. Comparative Example

Regarding a head mounted display, a high resolution and a great viewing angle are desired. An existing head mounted display is mainly configured to view a display panel through a lens (a single lens, or sometimes a plurality of lenses for aberration correction), and uses a several-inch-sized display panel to achieve a great viewing angle. However, when the number of pixels is increased with such a panel size to increase the resolution, manufacturing becomes difficult, resulting in a poor yield. This increases cost, which is an issue. Meanwhile, a small-sized 4K panel of about 1 inch (25.4 mm diagonal) called a micro-display has been recently developed. Accordingly, it is reasonable to use such a 4K panel to increase the resolution of the head mounted display.

However, in a case of using a micro-display in an existing head mounted display including an observation optical system with a single lens, the viewing angle is reduced as the panel size is reduced. To compensate for this drawback, an observation optical system has been developed for a long time to achieve a great viewing angle with a small panel size.

In such development, there are an increasing number of techniques, for example, a tiling technique, that combine a plurality of observation optical systems and display panels to obtain a great viewing angle as a whole. In contrast, referring to an embodiment of the present disclosure described later, presented is an observation optical system that uses only one display panel having a size of 1 inch (25.4 mm diagonal) or smaller for one eye (that is, two display panels for both eyes) to achieve both a great horizontal viewing angle of 110 degrees or more and a reduction in size and weight that is necessary as a head mounted display. A half of the diagonal of the 1-inch panel is 12.7 mm. Therefore, with use of a half viewing angle of 55 degrees, a focal length determined by paraxial calculation is 8.9 mm. Because a pupil diameter needs to be about 12 mm when taking into consideration the rotation of the eyeball, the F-number, for a camera lens, is equivalent to that of a specification having a wide-angle lens of 0.8 or less, which is very difficult to be achieved as a specification for a lens.

Observation optical systems described in PTL 1 (Japanese Unexamined Patent Application Publication No. 2017-211474) and PTL 2 (Japanese Unexamined Patent Application Publication No. 2018-106167) are developed on the basis of currently commercialized optical types.

The observation optical system described in PTL 1 (Japanese Unexamined Patent Application Publication No. 2017-211474) achieves a half viewing angle of 45 degrees by using two Fresnel lenses. Because the technique described in PTL 1 does not aim to reduce the panel size, if the resolution is increased (the number of pixels is increased) with such a panel size, it becomes considerably expensive.

The observation optical system described in PTL 2 (Japanese Unexamined Patent Application Publication No. 2018-106167), using three lenses including a Fresnel lens, achieves a viewing angle of 80 degrees with an image plane size (panel size) of 19.9 mm diagonal, allowing for the use of a small display panel. However, with the configuration of the observation optical system described in PTL 2, when an attempt is made to achieve a great viewing angle with a small display panel, the optical path is designed to be greatly bent a plurality of times in the middle, thus sometimes lead to occurrence of a large aberration. PTL 2 does not teach to increase the horizontal viewing angle to 110 degrees or more. It is difficult to obtain a great viewing angle of 110 degrees or more with such a small display panel.

Meanwhile, although it is not commercialized much, another way to achieve a wide viewing angle with a small display panel is to use a relay optical system that once forms an intermediate image in an observation optical system.

PTL 3 (Japanese Unexamined Patent Application Publication No. H10-153748) and PTL 4 (Japanese Unexamined Patent Application Publication No. 2004-341411) each disclose a relay optical system using a free-form surface prism. The relay optical system described in each of PTL 3 and PTL 4 has a configuration that forms an intermediate image in the prism, and forms the intermediate image in a reduced manner at a position of a panel with an optical system after that. A disadvantage of this relay optical system is that, when attempting to reduce the size of the relay optical system, because an optical surface in which optical paths overlap with each other is often present, it is necessary to provide a reflection surface having a characteristic that transmits light entering from the left and reflects light entering from the right, for example. In such a case, the light amount efficiency may be optimal if a full reflection condition is satisfied at the time of reflection; however, it is very difficult to satisfy the full reflection condition for all light rays with an increased viewing angle. Therefore, practically, a film having a semi-transmissive characteristic needs to be used for the reflection surface. Accordingly, a loss in light amount and stray light are unavoidable in most cases.

Moreover, in the relay optical system described in each of PTL 3 and PTL 4, the reflection surface is provided at an optical device (the free-form surface prism) closest to the eye. However, light is spread the most at such a location. Therefore, the free-form surface prism can be greatly increased in size with the increased viewing angle. Further, the horizontal viewing angle is 50 degrees, and it is very difficult to further increase the viewing angle.

PTL 5 (Japanese Unexamined Patent Application Publication No. 2013-25102) discloses a relay optical system using two free-form surface prisms. A concave reflection surface is provided at the optical device (the free-form surface prism) closest to the eye also in the relay optical system described in PTL 5. As described above, light is spread the most at such a location. Therefore, the free-form surface prism can be greatly increased in size with the increased viewing angle. Further, because light is reflected only once in the free-form surface prism, the light returns in a direction toward a face and the reflected light passes near the eye. Therefore, it is difficult to use it while wearing glasses unless a distance from the eye to the free-form surface prism is considerably increased. The horizontal viewing angle is 80 degrees, but it is difficult to further increase the viewing angle with this relay optical system unless the optical system size is considerably increased.

### 1. Overview

### [1.1 Overview of Observation Optical System and Image Display Apparatus According to Embodiment of Present Disclosure]

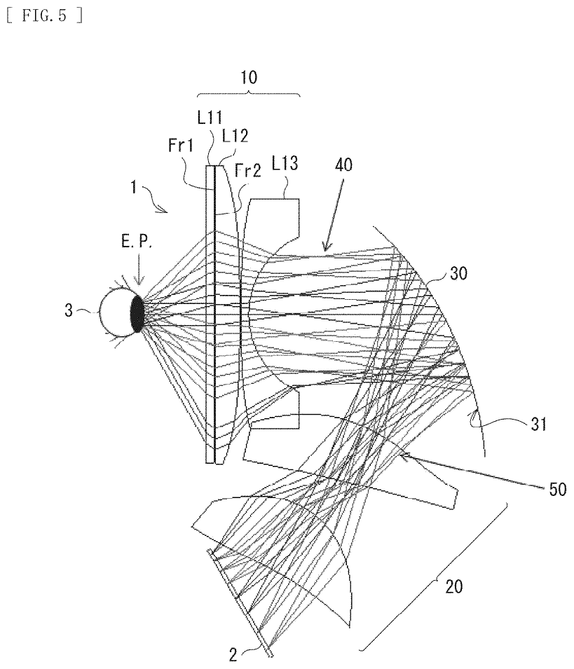

FIG. 1 illustrates an example of a state in which an image display apparatus using an observation optical system 1 according to an embodiment of the present disclosure is mounted on a head of a viewer 4. Further, FIG. 5 illustrates a cross-sectional configuration example of the observation optical system 1 and the image display apparatus according to the embodiment.

The image display apparatus according to the embodiment includes an image display unit and the observation optical system 1 that enlarges an image displayed on the image display unit. The image display unit includes, for example, a display panel 2 such as a liquid crystal display or an OLED (organic EL) display. The display panel 2 corresponds to one specific example of an “image display unit” in the technique of the present disclosure.

The observation optical system 1 according to the embodiment includes, in order from the side closer to an entrance pupil (eye point) E.P., a front optical system 10, a reflective optical device 30 including at least one reflection surface 31, and a rear optical system 20. The front optical system 10 corresponds to one specific example of a “first lens group” in the technique of the present disclosure. The rear optical system 20 corresponds to one specific example of a “second lens group” in the technique of the present disclosure.

The front optical system 10 is disposed at a position closer to the entrance pupil E.P. than the reflective optical device 30. The front optical system 10 forms an intermediate image 40 of a virtual image corresponding to an image displayed on the display panel 2, on the reflection surface 31 or at a position closer to the entrance pupil E.P. than the reflection surface 31. Note that the reflective optical device 30 may include a plurality of reflection surfaces 31. In this case, the intermediate image 40 is formed at a position closer to the entrance pupil E.P. than the reflection surface 31 which light first enters, in a case where ray tracing is performed from an entrance pupil E.P. side.

The rear optical system 20 is disposed on an optical path after light passes through the front optical system 10, the intermediate image 40, and the reflective optical device 30 in order in the case where the ray tracing is performed from the entrance pupil E.P. side, and is so disposed that an image of the entrance pupil E.P. is formed on an optical path after the light is reflected by the reflection surface 31.

In the present disclosure, as one embodiment, presented is the observation optical system 1 that uses only one display panel 2 having a size of 1 inch (25.4 mm diagonal) or less for one eye 3 (that is, two display panels 2 for both eyes), to thereby achieve a great horizontal viewing angle of 110 degrees or greater and to also achieve a reduction in size and weight necessary as a head mounted display.

A thin head mounted display (especially having a small thickness from the eye 3 in a front direction) is generally preferred. A thick head mounted display has a center of gravity that is away from the face. This easily applies pressure on a part of a face upon use, which is uncomfortable. It may also be an issue that it comes down upon use. With the observation optical system, such as those disclosed in PTL 1 and PTL 2 described above, that uses a single lens (including that uses a plurality of lenses for aberration correction), it is easy to achieve a thin head mounted display; however, a head mounted display achieving a great horizontal viewing angle of 110 degrees or more with the display panel 2 of 1 inch (25.4 mm diagonal) or less has not been known yet.

Therefore, the observation optical system 1 according to the embodiment has a configuration that, in a case where ray tracing is performed from the entrance pupil E.P. side, once forms the intermediate image 40 having a size greater than that of the display panel 2, and thereafter relays the intermediate image 40 to form the image again with a desired panel size. Note that, regarding the embodiment of the present disclosure, the description is given on the assumption that the virtual image is set as an object plane, the display panel 2 is set as an image plane, and light travels in a direction opposite to that of an actual optical path observed by the viewer 4, unless otherwise specified.

In the observation optical system 1 according to the embodiment, an image, which is formed at a position of the display panel 2 in a typical observation optical system, is once formed as the intermediate image 40. Accordingly, an optical system that relays it thereafter is needed. Therefore, the total length becomes very long compared with that of the typical observation optical system, which can easily result in an issue related to comfortableness in wearing. To address this, as illustrated in FIG. 1, the observation optical system 1 according to the embodiment has an arrangement that bends the optical path in a direction toward the ear in the middle although the size is increased in a direction of a width of the face. Although the additional optical system after the intermediate image 40 makes the head mounted display a little heavier, the center of gravity is made closer to the face compared with that with a non-bent optical path. The pressure upon wearing it is also allowed to be distributed in a wide area of the head. This can solve the issue related to the comfortableness and stability upon wearing the head mounted display. As illustrated in FIG. 1, the observation optical system 1 according to the embodiment is configured to allow the display panel 2 to be disposed closer to the ear side than the eye 3 when viewed from the front of the face, and the display panel 2 to be disposed closer to the face side than the reflection surface 31 of the reflective optical device 30 when viewed from the side of the face.

In the observation optical system 1 according to the embodiment, if the reflection surface 31 bending the optical path has positive power, it acts in a direction of suppressing distortion, which is advantageous in achieving a wide viewing angle. The relay optical system described in PTL 3, etc. described above also includes the reflection surface 31; however, the reflection surface 31 is disposed at the optical device (the free-form surface prism) closest to the eye 3 which light exiting the eye 3 reaches first.

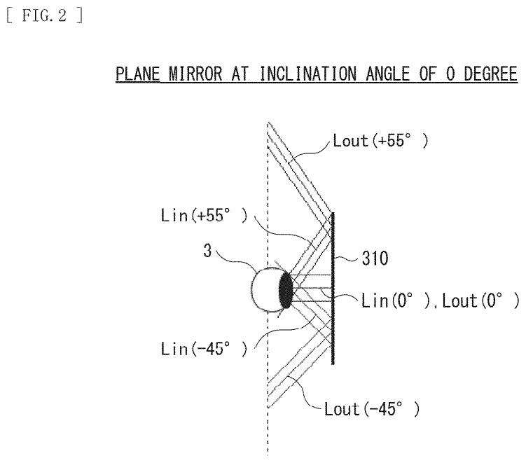

It is described below with simple simulations illustrated in FIGS. 2 to 4 that it is difficult to increase the viewing angle if the reflection surface 31 is disposed at a location closest to the eye 3 (the entrance pupil E.P.).

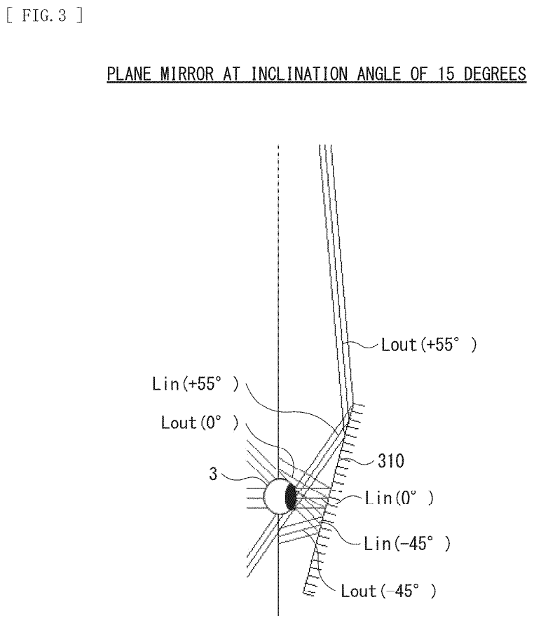

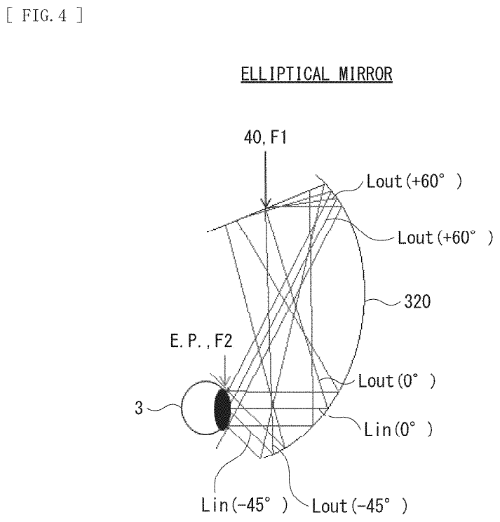

FIG. 2 illustrates an example of a state of reflected light in an observation optical system using a plane mirror 310 at an inclination angle of 0 degree. FIG. 3 illustrates an example of a state of reflected light in an observation optical system using the plane mirror 310 at an inclination angle of 15 degrees. FIG. 4 illustrates an example of a state of reflected light in an observation optical system using an elliptical mirror 320.

FIGS. 2 and 3 each illustrate an optical path of reflected light Lref(0°) in a case where light Lin(0°) enters the plane mirror 310 at an entering angle of 0 degree, an optical path of reflected light Lref(+55°) in a case where light Lin(+55°) enters the plane mirror 310 at an entering angle of +55 degrees, and an optical path of reflected light Lref(−45°) in a case where light Lin(−45°) enters the plane mirror 310 at an entering angle of −45°. FIG. 4 illustrates an optical path of reflected light Lref(0°) in a case where light Lin(0°) enters the elliptical mirror 320 at an entering angle of 0 degree, an optical path of reflected light) Lref(+60°) in a case where light Lin(+60°) enters the elliptical mirror 320 at an entering angle of +60 degrees, and an optical path of reflected light Lref(−45°) in a case where light Lin(−45°) enters the elliptical mirror 320 at an entering angle of −45°.

In a case of a great viewing angle, it is difficult to prevent all of the reflected light from returning in a direction toward the eye 3 only by varying the inclination of the reflection surface 31. Note that the observation optical system described in PTL 5 (Japanese Unexamined Patent Application Publication No. 2013-25102) involves back reflection through a single refractive surface and the reflection surface 31 also has a curvature. Therefore, although it is not an extreme example as illustrated in FIGS. 2 and 3, it is still difficult to eliminate the light returning in the direction toward the eye 3 with an increased viewing angle.

However, considering the eccentric elliptical mirror 320 as in the example illustrated in FIG. 4, it is possible to collect principal rays to a focal point. It is therefore possible to achieve an arrangement that prevents returning to the eye 3 if the focal position is appropriately selected. For example, as illustrated in FIG. 4, an arrangement is possible in which a position of one focal point F1 of ellipse corresponds to the intermediate image 40, and a position of another focal point F2 of ellipse corresponds to the entrance pupil E.P. However, in this case, an image formation performance is too low (it is too difficult to collect, toward the principal rays, light rays other than the principal rays), which makes it very difficult to configure the optical system disposed after the reflection surface 31.

As described above, with the configuration that provides the reflection surface 31 at the optical device disposed at a position close to the eye 3 as in the existing optical type, it is very difficult to aim an increase in viewing angle. Accordingly, the observation optical system 1 according to the embodiment has a configuration of a new type of optical system different from those of the existing optical systems.

In the observation optical system 1 according to the embodiment, the front optical system 10, the reflective optical device 30, and the rear optical system 20 each have positive power.

The front optical system 10 forms the intermediate image 40 at a position the same as that of the reflection surface 31 in the reflective optical device 30 or at a position closer to the eye 3 side than the reflection surface 31. The front optical system 10 also provides a pupil at a position after (on the display panel 2 side of) the reflection surface 31 in the reflective optical device 30.

The intermediate image 40 is conjugate to a virtual image provided by the observation optical system 1. Further, the intermediate image 40 is a real image. The size of the intermediate image 40 is greater than the panel size of the display panel 2 (the size of an image displayed on the display panel 2). However, the intermediate image 40 is reduced by the reflective optical device 30 and the rear optical system 20, and is formed on the display panel 2 with a desired panel size.

The front optical system 10 includes an axisymmetric optical system including one or more axisymmetric lenses. The configuration example in FIG. 5 illustrates an example of a three-lens configuration including a first lens L11, a second lens L12, and a third lens L13. The front optical system 10 may have a Fresnel surface. In the configuration example in FIG. 5, a surface, of the first lens L11, that opposes the second lens L12 is a first Fresnel surface Fr1, and a surface, of the second lens L12, that opposes the first lens L11 is a second Fresnel surface Fr2.

The reflective optical device 30 and the rear optical system 20 are eccentric and tilted with respect to the front optical system 10. The reflective optical device 30 has an axisymmetric shape that is tilted with respect to the front optical system 10 or a free-form surface shape.

The rear optical system 20 has at least one free-form surface. The rear optical system 20 is an eccentric optical system that does not have an axisymmetric axis as a whole. It is necessary to tilt the reflective optical device 30 to reflect light while avoiding the direction toward the eye 3. Therefore, non-axisymmetric aberration generally occurs in the reflective optical device 30. In order to correct the aberration, it is necessary to make the rear optical system 20 eccentric or to provide the rear optical system 20 with the free-form surface.

In the observation optical system 1 according to the embodiment, it is important to form the intermediate image 40 closer to the eye 3 side (on the front optical system 10 side) than the reflection surface 31 in the reflective optical device 30. Thereby, owing to the working of the reflective optical device 30, a real pupil image (an image of the entrance pupil E.P.) 50 is formed on the rear side of the reflection surface 31 (between the reflection surface 31 and the rear optical system 20 or inside the rear optical system 20). This allows the reflection surface 31 to be disposed in a place sandwiched by the intermediate image 40 and the real pupil image 50. Accordingly, it is possible to limit the size of the reflective optical device 30 and a range of the spreading of the light that passes on the front side and the rear side of the reflective optical device 30 to be small. As a result, it becomes possible to achieve a small-sized head mounted display even with a great viewing angle. As in the existing observation optical system, if light enters the reflective optical device 30 before the intermediate image 40 is formed, the great spreading of the light makes the reflection surface 31 excessively large. This makes it difficult to provide a great viewing angle. Further, even if such a design is achieved, the head mounted display can be very large in size as a whole.

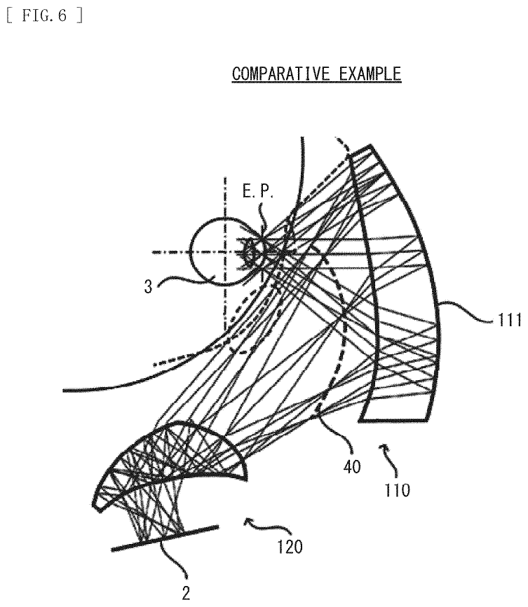

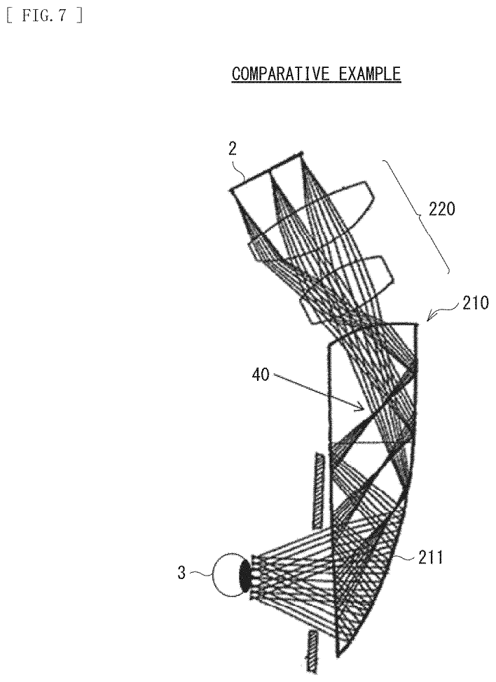

FIGS. 6 and 7 schematically illustrate configuration examples of observation optical systems and image display apparatuses according to first and second comparative examples, respectively.

The observation optical system according to the first comparative example illustrated in FIG. 6 corresponds to a configuration of the observation optical system described in PTL 5 described above. The observation optical system according to the first comparative example includes a free-form surface prism 110 and a free-form surface prism 120 in order from the eye 3 side. The free-form surface prism 110 includes a reflection surface 111.

The observation optical system according to the second comparative example illustrated in FIG. 7 corresponds to a configuration of the observation optical system described in PTL 3 described above. The observation optical system according to the second comparative example includes a free-form surface prism 210 and a light collection optical system 220 in order from the eye 3 side. The free-form surface prism 210 includes a reflection surface 211.

In the observation optical system according to any of the first and the second comparative examples illustrated in FIGS. 6 and 7, in a case where light enters from the eye 3 side, the light is reflected by the reflection surface 111 or 211, and the intermediate image 40 is formed thereafter. In this case, however, it is difficult to increase the viewing angle. In contrast, in the observation optical system 1 according to the embodiment, in a case where light enters from the eye 3 side, the light is reflected by the reflection surface 31 after the intermediate image 40 is formed, as illustrated in FIG. 5. It is therefore easier to increase the viewing angle.

### [1.2 Effects and Modifications]

As described above, according to the observation optical system 1 and the image display apparatus according to the embodiment, it is possible to achieve both an increase in viewing angle and a reduction in size and weight.

According to the observation optical system 1 and the image display apparatus according to the embodiment, it is possible to achieve a small-sized head mounted display with a great horizontal viewing angle using a high-resolution micro-display.

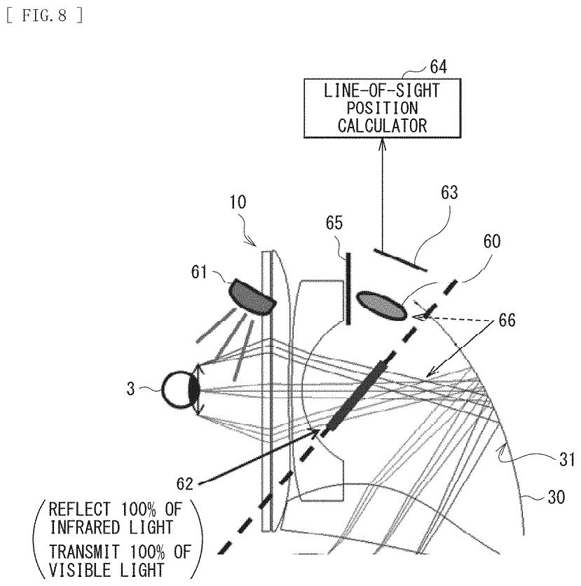

FIG. 8 schematically illustrates a first modification of the observation optical system 1 and the image display apparatus according to the embodiment. The observation optical system 1 according to the embodiment has a space between the front optical system 10 and the reflection surface 31. Therefore, it is relatively easy to dispose a line-of-sight detection optical system.

For example, as in the first modification illustrated in FIG. 8, the eye 3 of the viewer 4 is applied with light with use of a light source 61 such as an infrared LED (Light Emitting Diode), an imaging optical system (an image formation optical system 60) is disposed in a space between the front optical system 10 and the reflection surface 31, and an image of the eye 3 is constantly taken into an imaging device 63, making it possible to monitor a movement of the eye 3. In this case, a dichroic mirror 62 as a beam splitter is disposed in an optical path between the front optical system 10 and the reflective optical device 30. Ideally, the dichroic mirror 62 has a characteristic of reflecting 100% of infrared light and transmitting 100% of visible light. Thus, the dichroic mirror 62 splits reflected light (infrared light) of the light from the light source 61 reflected by the eye 3 of the viewer 4 and light (visible light) of the observation image reflected by the eye 3 of the viewer 4. The image formation optical system 60 is disposed at a position, corresponding to an exit pupil 66 of the observation optical system 1, in the optical path of the reflected light that has been subjected to the splitting by the dichroic mirror 62. It is preferable that a blindfold plate 65 be disposed closer to the eye 3 side than the image formation optical system 60 and the imaging device 63. The blindfold plate 65 is adapted to prevent the image formation optical system 60 and the imaging device 63 to be viewed by the viewer 4. The reflected light of the light from the light source 61 that has been reflected by the eye 3 of the viewer 4 enters the imaging device 63 via the image formation optical system 60. A line-of-sight position calculator 64 calculates a light-of-sight position of the viewer 4 on the basis of a result of imaging performed by the imaging device 63.

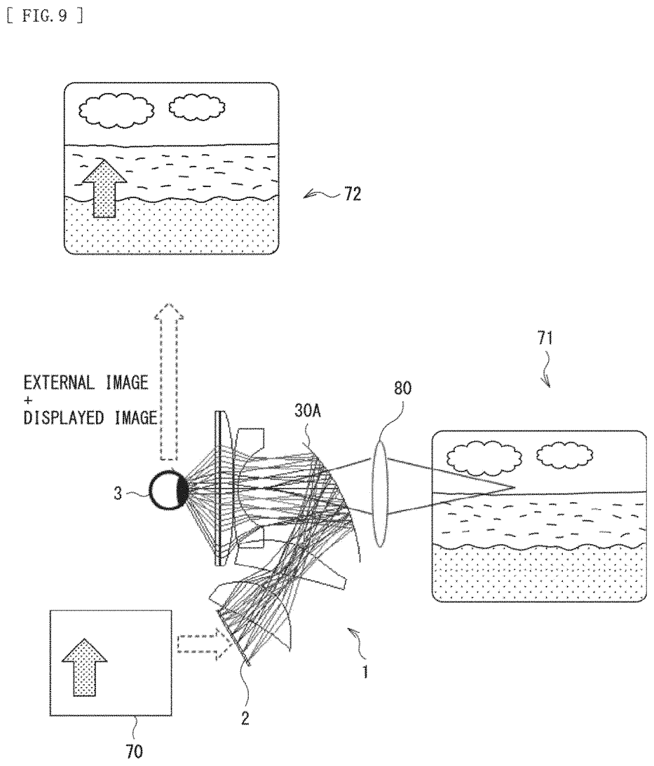

FIG. 9 schematically illustrates a second modification of the observation optical system 1 and the image display apparatus according to the embodiment.

As illustrated in FIG. 9, in the observation optical system 1 according to the embodiment, the reflective optical device 30 may be a reflective optical device 30A, such as a semi-transmissive mirror, that has a semi-transmissive characteristic of transmitting external light. In this case, if an appropriate additional optical system (an image formation optical system) 80 is added on the rear side of the reflective optical device 30A, it is possible to achieve a see-through type head mounted display. Thereby, for example, the viewer 4 is allowed to view an observation image 72 including a displayed image 70 displayed on the display panel 2 and an external image 71 superimposed thereon. The external image 71 may be an outside scenery or may be a displayed image displayed on an external display panel.

Note that the effects described herein are merely illustrative and not limitative, and any other effect may be provided.

### EXAMPLES

### 2. Numerical Examples of Optical System

### Example 1

FIG. 10 illustrates a cross-sectional configuration of an observation optical system 1A and an image display apparatus according to Example 1.

As illustrated in FIG. 10, the reflective optical device 30 of the observation optical system 1A according to Example 1 includes a single reflection mirror. In the observation optical system 1A according to Example 1, three axisymmetric lenses (a first lens L11, a second lens L12, and a third lens L13) are disposed on the front side (on the eye 3 side) of the reflection surface 31. The intermediate image 40 is formed immediately after them. The intermediate image 40 is closer to the eye 3 side than the reflection surface 31, and the real pupil image 50 is formed on the rear side of the reflection surface 31.

In the observation optical system 1A according to Example 1, the front optical system 10 has a three-lens configuration in which the first lens L11, the second lens L12, and the third lens L13 are disposed in order from the eye 3 side. The front optical system 10 includes two Fresnel surfaces, contributing to a reduction in thickness. Specifically, a surface, of the first lens L11, opposing the second lens L12 is a first Fresnel surface Fr1, and a surface, of the second lens L12, opposing the first lens L11 is a second Fresnel surface Fr2. The Fresnel surface is formed, for example, on a planar substrate surface. An upper limit and a lower limit of a sag amount of the Fresnel surface is determined by two mutually parallel planar surfaces. Generally, the first Fresnel surface Fr1 and the second Fresnel surface Fr2 may each be a curved surface, and are not necessarily parallel to each other.

In the observation optical system 1A according to Example 1, the real pupil image 50 is formed in the rear optical system 20. The rear optical system 20 includes two free-form surfaces, and corrects non-axisymmetric aberration occurring at the reflection surface 31.

Note that, in the observation optical system 1A according to Example 1, the viewing angle on the nose side which is difficult to follow by the eye 3 is great, and the viewing angle on the ear side is greater than that in an upper-lower direction (especially, in an upper direction). However, this is non-limiting. The viewing angle is as follows.

Viewing Angle

Y-direction (horizontal): −57.5 degrees (ear side)˜+45 degrees (nose side)
X-direction (vertical): −30 degrees˜+30 degrees

In a case where the front optical system 10 includes a Fresnel lens, it is possible to achieve an image display apparatus having a favorable optical performance while being small in size and light in weight by satisfying two inequality expressions of the following conditional expressions (1) and (2). Note that, in the conditional expression (1), fb is a focal length of the front optical system 10, and E is a length of an eye relief. In the conditional expression (2), A is an image height of the intermediate image 40 in the vertical direction, and B is an image height in the vertical direction when the intermediate image 40 is formed on the display panel 2 with use of the reflective optical device 30 and the rear optical system 20, in a case where ray tracing is performed from the entrance pupil E.P. side.

1<fb/E<1.25 (1)

0.55<B/A<0.85 (2)

The conditional expression (1) is a condition that limits a position of the intermediate image 40 formed by the front optical system 10. If fb/E is less than 1, the aberration becomes worse, and if fb/E is greater than 1.25, the size of the optical system increases.

The conditional expression (2) is a condition that limits a lateral magnification in the vertical direction between the intermediate image 40 and the display panel 2. If B/A is less than a lower limit of the conditional expression (2), the optical system is increased in size. In contrast, if it exceeds an upper limit, the aberration becomes worse.

Note that, because the observation optical system 1A according to Example 1 is not axisymmetric, a magnification in the horizontal direction and a magnification in the vertical direction are generally different from each other, and the magnification in the horizontal direction has relatively more freedom in eccentricity etc., compared with the magnification in the vertical direction.

In the observation optical system 1A according to Example 1, in a case of light having a wavelength of 536 nm, the focal length fb of the front optical system 10 is: fb=14.32 mm. Because the length of the eye relief is: E=13 mm, fb/E=1.10. This satisfies the conditional expression (1).

In the observation optical system 1A according to Example 1, the image size in the vertical direction is determined by a principal ray of 0 degree in the horizontal direction and ±30 degrees in the vertical direction. In a case where real ray tracing is performed with the observation optical system 1A according to Example 1, the image height A of the intermediate image 40 in the vertical direction=±7.36 mm, and the image height B in the vertical direction on the display panel 2=±5.50 mm. This results in B/A=0.747. This satisfies the conditional expression (2).

Table 1 describes basic lens data of the observation optical system 1A according to Example 1. In Table 1, a 0th surface indicates an object plane (a virtual image), a 1st surface indicates the entrance pupil E.P. (having a diameter of 12 mm), an 8th surface indicates the intermediate image 40, and a 15th surface indicates the display panel surface (0.93 inches).

In Table 1, R indicates a curvature radius of a surface, D indicates a surface spacing on an optical axis, Nd indicates a refractive index with respect to a d-line, and vd indicates an Abbe's number with respect to the d-line. Further, in Table 1, a surface having a surface type of SPH and having an R value of 1e+18 represents a planar surface. REFR represents a refractive surface, and REFL represents the reflection surface 31. Further, in Table 1, “SPH” represents a spherical surface, and “ASP” represents an aspherical surface. An expression for an aspherical surface is as follows. Note that, in a case of a spherical surface, k=A=B=C=D=E=F=G=H=J=0 is established in the expression for an aspherical surface. This is similarly applicable to other examples described later.

$$Z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + {Hr}^{18} + {Jr}^{20} \qquad [ Math . 1 ]$$

where

z is a sag amount of a surface parallel to a z-axis,

c is a curvature (CUY) at a surface apex,

k is a conic constant,

A, B, C, D, E, F, G, H, and J are 4th-order, 6th-order, 8th-order, 10th-order, 12th-order, 14th-order, 16th-order, 18th-order, and 20th-order aspherical coefficients, respectively, and

r is a distance in a radius direction=\sqrt{x²+y²}

Further, in Table 1, “ASP-FRESNEL” represents a thin Fresnel surface. In a case of the thin Fresnel surface, the sag amount of the surface is always 0, but a calculation is made using (a differential value of) the above-described expression for an aspherical surface only in a case of calculating a normal to the surface. The thin Fresnel surface is an ideal case where ray tracing is performed without taking into consideration a real shape. As it ignores an upright wall part, stray light is not generated. Further, in Table 1, “SPS XYP” represents an XY polynomial surface. An expression for an XY polynomial surface is as follows (in a case of a 10th-order expression). This is similarly applicable to other examples described later.

$$Z = \frac{{cr}^{2}}{1 + \sqrt{1 - ( 1 + k ) {c}^{2} {r}^{2}}} + {\sum }_{j = 2}^{66} {C}_{j} {x}^{m} {y}^{n} , \\ j = \frac{{( m + n )}^{2} + m + 3 n}{2} + 1 \qquad [ Math . 2 ]$$

where

z is a sag amount of a surface parallel to a z-axis,

c is a curvature (CUY) at a surface apex,

k is a conic constant, and

Cj is a coefficient of a monomial x^{m}yⁿ.

TABLE 1
Example 1 Lens data

| Surface | | | | | | Reflection, |
|---|---|---|---|---|---|---|
| number | R | D | Nd | νd | Surface type | refraction |
| 0 | 1e+018 | −2500.0000 | 1.000 | | SPH | REFR |
| 1 | 1e+018 | 13.0000 | 1.000 | | SPH | REFR |
| 2 | 1e+018 | 1.5004 | 1.535 | 55.7 | SPH | REFR |
| 3 | −11.6648 | 0.3000 | 1.000 | | ASP-FRESNEL | REFR |
| 4 | 11.5153 | 4.6224 | 1.535 | 55.7 | ASP-FRESNEL | REFR |
| 5 | −505.9486 | 0.2000 | 1.000 | | ASP | REFR |
| 6 | 332.6368 | 1.5015 | 1.661 | 20.4 | ASP | REFR |
| 7 | 16.5942 | 8.5896 | 1.000 | | ASP | REFR |
| 8 | 1e+018 | 33.4202 | 1.000 | | SPH | REFR |
| 9 | 1e+018 | −22.2915 | 1.000 | | SPS XYP | REFL |
| 10 | 1e+018 | −11.0206 | 1.535 | 55.7 | SPS XYP | REFR |
| 11 | −461.6064 | −18.7353 | 1.000 | | SPH | REFR |
| 12 | 1e+018 | −5.9755 | 1.535 | 55.7 | SPS XYP | REFR |
| 13 | −51.0227 | −13.1717 | 1.000 | | ASP | REFR |
| 14 | 1e+018 | −0.7000 | 1.517 | 64.2 | SPH | REFR |
| 15 | 1e+018 | 0.0000 | 1.517 | 64.2 | SPH | REFR |

Table 2 describes aspherical coefficients of the observation optical system 1A according to Example 1. Table 3 describes eccentricity data of the observation optical system 1A according to Example 1. The eccentricity data describes coordinates (XDE, YDE, ZDE) of a surface of interest using a surface immediately before the surface of interest as a reference and Euler angles (ADE, BDE, CDE) for each surface. XDE, YDE, and ZDE correspond to eccentric amounts, and ADE, BDE, and CDE correspond to tilt angles. ADE refers to an amount by which the mirror or the lens is rotated about the X-axis from the Z-axis direction to the Y-axis direction. BDE refers to an amount by which it is rotated about the Y-axis from the X-axis direction to the Z-axis direction. CDE refers to an amount by which it is rotated about the Z-axis from the X-axis direction to the Y-axis direction. Note that a lateral direction of the display surface of the display panel 2 is set as the X-axis, a vertical direction is set as the Y-axis, and a direction perpendicular to the display surface is set as the Z-axis. This is similarly applicable to other examples described later.

TABLE 2
Example 1 Aspherical coefficients

| Surface | | | | |
|---|---|---|---|---|
| number | A | B | C | D |
| 3 | −3.5890e−005 | 1.4214e−008 | 1.4395e−011 | 0.0000e+000 |
| 4 | 4.9963e−007 | −1.8373e−008 | 0.0000e+000 | 0.0000e+000 |
| 5 | −3.7825e−006 | 0.0000e+000 | 0.0000e+000 | 0.0000e+000 |
| 6 | 4.7645e−006 | 0.0000e+000 | 0.0000e+000 | 0.0000e+000 |
| 7 | 1.2348e−005 | 7.6170e−010 | 0.0000e+000 | 0.0000e+000 |
| 13 | 5.5011e−006 | 0.0000e+000 | 0.0000e+000 | 0.0000e+000 |

| Surface | | | |
|---|---|---|---|
| number | E | F | G |
| 3 | 0.0000e+000 | 0.0000e+000 | 0.0000e+000 |
| 4 | 0.0000e+000 | 0.0000e+000 | 0.0000e+000 |
| 5 | 0.0000e+000 | 0.0000e+000 | 0.0000e+000 |
| 6 | 0.0000e+000 | 0.0000e+000 | 0.0000e+000 |
| 7 | 0.0000e+000 | 0.0000e+000 | 0.0000e+000 |
| 13 | 0.0000e+000 | 0.0000e+000 | 0.0000e+000 |

TABLE 3
Example 1 Eccentricity data

| Surface | | | | | | |
|---|---|---|---|---|---|---|
| number | XDE | YDE | ZDE | ADE | BDE | CDE |
| 0 | 0.0000 | 0.0000 | 0.0000 | 0.0000 | 0.0000 | 0.0000 |
| 1 | 0.0000 | 0.0000 | 0.0000 | 0.0000 | 0.0000 | 0.0000 |
| 2 | 0.0000 | 0.0000 | 0.0000 | −0.0000 | −0.0000 | 0.0000 |
| 3 | 0.0000 | 0.0000 | 0.0000 | −0.0000 | −0.0000 | 0.0000 |
| 4 | 0.0000 | 0.0000 | 0.0000 | −0.0000 | −0.0000 | 0.0000 |
| 5 | 0.0000 | 0.0000 | 0.0000 | −0.0000 | −0.0000 | 0.0000 |
| 6 | 0.0000 | 0.0000 | 0.0000 | −0.0000 | −0.0000 | 0.0000 |
| 7 | 0.0000 | 0.0000 | 0.0000 | −0.0000 | −0.0000 | 0.0000 |
| 8 | 0.0000 | 0.0000 | 0.0000 | −0.0000 | −0.0000 | 0.0000 |
| 9 | 0.0000 | −11.8626 | 0.0000 | 22.0462 | 0.0000 | 0.0000 |
| 10 | 0.0000 | −1.0638 | 0.0000 | 54.5276 | 0.0000 | 0.0000 |
| 11 | 0.0000 | 0.0000 | 0.0000 | −0.0000 | −0.0000 | 0.0000 |
| 12 | 0.0000 | −4.6874 | 0.0000 | −26.9619 | 0.0000 | 0.0000 |
| 13 | 0.0000 | 0.0000 | 0.0000 | −0.0000 | −0.0000 | 0.0000 |
| 14 | 0.0000 | 4.5743 | 0.0000 | −19.1512 | 0.0000 | 0.0000 |
| 15 | 0.0000 | 0.0000 | 0.0000 | −0.0000 | −0.0000 | 0.0000 |

Further, coefficients of the XY polynomial surface of the observation optical system 1A according to Example 1 are described below.

### Example 1•Coefficients Cj of XY Polynomial Surface

9th Surface

C3: 7.604e-002
C4: −6.646e-003
C6: −7.025e-003
C8: −8.774e-005
C10: 6.387e-006
C11: −2.935e-007
C13: 1.427e-006
C15: −8.103e-007
C17: −2.074e-008
C19: −5.927e-008
C21: −4.857e-009

10th Surface

C3: 1.768e-001
C4: −2.533e-002
C6: −1.855e-002
C8: 1.254e-004
C10: −1.291e-004
C11: −6.278e-006
C13: 3.311e-006
C15: 1.098e-005
C17: −1.242e-007
C19: −3.804e-007
C21: −2.045e-007

12th Surface

C3: 9.553e-001
C4: −3.234e-002
C6: −5.075e-002
C8: 5.306e-004
C10: 1.077e-003
C11: 1.275e-005
C13: −3.044e-005
C15: −2.071e-005
C17: −3.523e-007
C19: −1.891e-008
C21: −7.865e-009

### Example 2

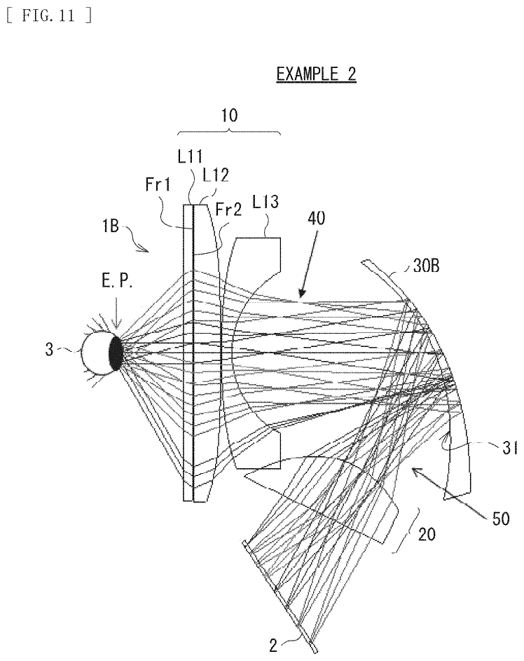

FIG. 11 illustrates a cross-sectional configuration of an observation optical system 1B and an image display apparatus according to Example 2.

As illustrated in FIG. 11, the observation optical system 1B according to Example 2 is a configuration example in which the reflective optical device 30 is changed to a reflective optical device 30B including a free-form surface prism compared with the configuration of the observation optical system 1A according to Example 1. The reflective optical device 30B includes a single reflection surface 31 and a single refractive surface, and has a Littrow configuration (an entering surface and an exiting surface are provided on the same surface). In the observation optical system 1B according to Example 2, the reflection surface 31 is a concave surface (back reflection). However, if the reflective optical device 30B as a whole has positive power, the reflection surface 31 may be a planar surface or a convex surface.

The viewing angle of the observation optical system 1B according to Example 2 is as follows.

Viewing Angle

Y-direction (horizontal): −57.5 degrees (ear side)˜+45 degrees (nose side)
X-direction (vertical): −30 degrees˜+30 degrees

In the observation optical system 1B according to Example 2, in a case of light having a wavelength of 536 nm, the focal length fb of the front optical system 10 is: fb=13.36 mm. Because the length of the eye relief is: E=13 mm, fb/E=1.03. This satisfies the conditional expression (1).

In the observation optical system 1B according to Example 2, the image size in the vertical direction is determined by a principal ray of 0 degree in the horizontal direction and ±30 degrees in the vertical direction. In a case where real ray tracing is performed with the observation optical system 1B according to Example 2, the image height A of the intermediate image 40 in the vertical direction=±6.84 mm, and the image height B in the vertical direction on the display panel 2=±4.50 mm. This results in B/A=0.658. This satisfies the conditional expression (2).

Note that, because the observation optical system 1B according to Example 2 is not axisymmetric, a magnification in the horizontal direction and a magnification in the vertical direction are generally different from each other, and the magnification in the horizontal direction has relatively more freedom in eccentricity etc., compared with the magnification in the vertical direction.

Table 4 describes basic lens data of the observation optical system 1B according to Example 2. In Table 4, a 0th surface indicates an object plane (a virtual image), a 1st surface indicates the entrance pupil E.P. (having a diameter of 12 mm), an 8th surface indicates the intermediate image 40, and a 15th surface indicates the display panel surface (0.93 inches). In Table 4, R represents a curvature radius of a surface, D represents a surface spacing on an optical axis, Nd represents a refractive index with respect to a d-line, and vd represents an Abbe's number with respect to the d-line. Further, in Table 4, a surface having a surface type of SPH and having an R value of 1e+18 represents a planar surface. REFR represents a refractive surface, and REFL represents the reflection surface 31. In Table 4, “SPH” represents a spherical surface, and “ASP” represents an aspherical surface. An expression for an aspherical surface is similar to that in Example 1. “ASP-FRESNEL” represents a thin Fresnel surface, as in Example 1. In Table 4, “SPS XYP” represents an XY polynomial surface. An expression for an XY polynomial surface is similar to that in Example 1.

Table 5 describes aspherical coefficients of the observation optical system 1B according to Example 2. Table 6 describes eccentricity data of the observation optical system 1B according to Example 2. The eccentricity data describes coordinates of a surface of interest using a surface immediately before the surface of interest as a reference and Euler angles for each surface.

TABLE 4
Example 2 Lens data

| Surface | | | | | | Reflection, |
|---|---|---|---|---|---|---|
| number | R | D | Nd | νd | Surface type | refraction |
| 0 | 1e+018 | −2500.0000 | 1.000 | | SPH | REFR |
| 1 | 1e+018 | 13.0000 | 1.000 | | SPH | REFR |
| 2 | 1e+018 | 1.8004 | 1.535 | 55.7 | SPH | REFR |
| 3 | −11.6763 | 0.3000 | 1.000 | | ASP-FRESNEL | REFR |
| 4 | 11.3249 | 5.0733 | 1.535 | 55.7 | ASP-FRESNEL | REFR |
| 5 | −2516.9320 | 0.2000 | 1.000 | | ASP | REFR |
| 6 | 145.5747 | 1.9998 | 1.661 | 20.4 | ASP | REFR |
| 7 | 17.2262 | 7.2234 | 1.000 | | ASP | REFR |
| 8 | 1e+018 | 34.9624 | 1.000 | | SPH | REFR |
| 9 | 1e+018 | 3.0000 | 1.535 | 55.7 | SPS XYP | REFR |
| 10 | 1e+018 | −3.0000 | 1.535 | 55.7 | SPS XYP | REFL |
| 11 | 1e+018 | −22.2915 | 1.000 | | SPS XYP | REFR |
| 12 | 1e+018 | −10.9255 | 1.535 | 55.7 | SPS XYP | REFR |
| 13 | 1e+018 | −12.8976 | 1.000 | | SPH | REFR |
| 14 | 1e+018 | −0.7000 | 1.517 | 64.2 | SPH | REFR |
| 15 | 1e+018 | 0.0000 | 1.517 | 64.2 | SPH | REFR |

TABLE 5
Example 2 Aspherical coefficients

| Surface | | | | |
|---|---|---|---|---|
| number | A | B | C | D |
| 3 | −3.4623e−005 | 1.5397e−008 | 1.5199e−011 | 0.0000e+000 |
| 4 | 2.5467e−007 | −1.8589e−008 | 0.0000e+000 | 0.0000e+000 |
| 5 | −3.8101e−006 | 0.0000e+000 | 0.0000e+000 | 0.0000e+000 |
| 6 | 4.9138e−006 | 0.0000e+000 | 0.0000e+000 | 0.0000e+000 |
| 7 | −4.6749e−006 | −5.5737e−009 | 0.0000e+000 | 0.0000e+000 |

| Surface | | | |
|---|---|---|---|
| number | E | F | G |
| 3 | 0.0000e+000 | 0.0000e+000 | 0.0000e+000 |
| 4 | 0.0000e+000 | 0.0000e+000 | 0.0000e+000 |
| 5 | 0.0000e+000 | 0.0000e+000 | 0.0000e+000 |
| 6 | 0.0000e+000 | 0.0000e+000 | 0.0000e+000 |
| 7 | 0.0000e+000 | 0.0000e+000 | 0.0000e+000 |

TABLE 6
Example 2 Eccentricity data

| Surface | | | | | | |
|---|---|---|---|---|---|---|
| number | XDE | YDE | ZDE | ADE | BDE | CDE |
| 0 | 0.0000 | 0.0000 | 0.0000 | 0.0000 | 0.0000 | 0.0000 |
| 1 | 0.0000 | 0.0000 | 0.0000 | 0.0000 | 0.0000 | 0.0000 |
| 2 | 0.0000 | 0.0000 | 0.0000 | −0.0000 | −0.0000 | 0.0000 |
| 3 | 0.0000 | 0.0000 | 0.0000 | −0.0000 | −0.0000 | 0.0000 |
| 4 | 0.0000 | 0.0000 | 0.0000 | −0.0000 | −0.0000 | 0.0000 |
| 5 | 0.0000 | 0.0000 | 0.0000 | −0.0000 | −0.0000 | 0.0000 |
| 6 | 0.0000 | 0.0000 | 0.0000 | −0.0000 | −0.0000 | 0.0000 |
| 7 | 0.0000 | 0.0000 | 0.0000 | −0.0000 | −0.0000 | 0.0000 |
| 8 | 0.0000 | 0.0000 | 0.0000 | −0.0000 | −0.0000 | 0.0000 |
| 9 | 0.0000 | −15.0271 | 0.0000 | 14.2052 | 0.0000 | 0.0000 |
| 10 | 0.0000 | 0.0000 | 0.0000 | −0.0000 | 0.0000 | 0.0000 |
| 11 | 0.0000 | 0.0000 | 0.0000 | −0.0000 | −0.0000 | 0.0000 |
| 12 | 0.0000 | 0.0588 | 0.0000 | 49.9423 | 0.0000 | 0.0000 |
| 13 | 0.0000 | 0.0000 | 0.0000 | −0.0000 | −0.0000 | 0.0000 |
| 14 | 0.0000 | 0.0000 | 0.0000 | −0.0000 | −0.0000 | 0.0000 |
| 15 | 0.0000 | 0.0000 | 0.0000 | −0.0000 | −0.0000 | 0.0000 |

Further, coefficients of the XY polynomial surface of the observation optical system 1B according to Example 2 are described below.

### Example 2•Coefficients Cj of XY Polynomial Surface

9th Surface

C3: 2.224e-001
C4: 1.243e-003
C6: −1.040e-002
C8: 2.434e-004
C10: 4.386e-006
C11: −4.386e-006
C13: −1.198e-005
C15: −3.244e-006
C17: −7.329e-008
C19: 1.500e-007
C21: 2.618e-008

10th Surface

C3: 8.089e-002
C4: −4.965e-003
C6: −7.940e-003
C8: 9.300e-005
C10: −3.885e-005
C11: −1.196e-006
C13: −4.240e-006
C15: −8.251e-007
C17: −6.626e-008
C19: −1.555e-009
C21: 2.364e-009

11th Surface

C3: 2.224e-001
C4: 1.243e-003
C6: −1.040e-002
C8: 2.434e-004
C10: 4.386e-006
C11: −4.386e-006
C13: −1.198e-005
C15: −3.244e-006
C17: −7.329e-008
C19: 1.500e-007
C21: 2.618e-008

12th Surface

C3: −1.867e-001
C4: −3.526e-002
C6: −3.206e-002
C8: −3.402e-004
C10: −2.008e-004
C11: −2.036e-006
C13: −6.142e-006
C15: −5.528e-006
C17: −3.819e-007
C19: −5.592e-007
C21: 3.134e-008

### Example 3

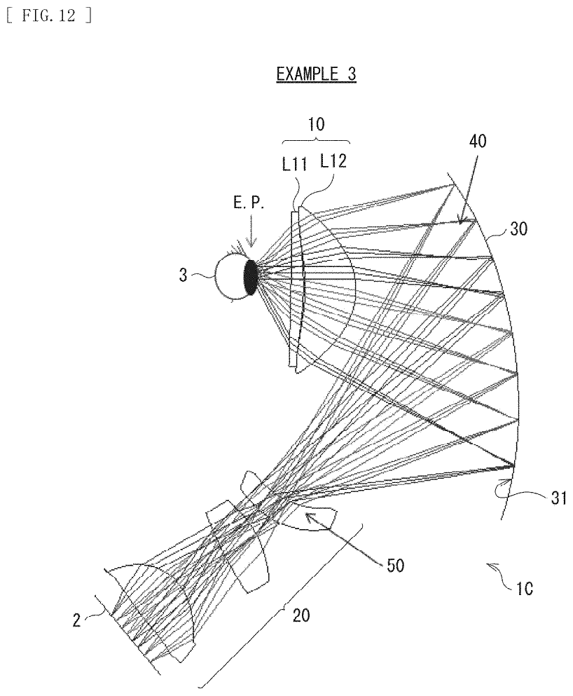

FIG. 12 illustrates a cross-sectional configuration of an observation optical system 1C and an image display apparatus according to Example 3.

The observation optical system 1A according to Example 1 and the observation optical system 1B according to Example 2 each use a Fresnel lens; however, the technology of the present disclosure does not necessarily need a Fresnel lens. In a case of not using a Fresnel lens, no stray light is generated, which is advantageous. Therefore, in some cases, it is preferable not to provide a Fresnel lens. In the observation optical system 1C according to Example 3, the front optical system 10 has a two-lens configuration including a first lens L11 and a second lens L12.

As illustrated in FIG. 12, in the observation optical system 1C according to Example 3, the intermediate image 40 is formed at a place closer to the reflection surface 31, compared with those in Examples 1 and 2. Meanwhile, the real pupil image 50 is formed at a place farther from the reflection surface 31. This is because a resin lens having a low refractive index which is not a Fresnel lens is used in the front optical system 10. If a glass having a high refractive index is used in the front optical system 10, it is possible to form the intermediate image 40 closer to the front optical system 10. Accordingly, it is possible to reduce the size although the weight is increased.

The viewing angle of the observation optical system 1C according to Example 3 is as follows.
Viewing Angle
   Y-direction (horizontal): −60 degrees (ear side)˜+45 degrees (nose side)
   X-direction (vertical): −30 degrees˜+30 degrees

In the observation optical system 1C according to Example 3, in a case of light having a wavelength of 536 nm, the focal length fb of the front optical system 10 is: fb=45.70 mm. Because the length of the eye relief is: E=13.7352 mm, fb/E=3.33. This does not satisfy the conditional expression (1).

In the observation optical system 1C according to Example 3, the image size in the vertical direction is determined by a principal ray of 0 degree in the horizontal direction and ±30 degrees in the vertical direction. In a case where real ray tracing is performed with the observation optical system 1C according to Example 3, the image height A of the intermediate image 40 in the vertical direction=±24.48 mm, and the image height B in the vertical direction on the display panel 2=±5.50 mm. This results in B/A=0.225. This does not satisfy the conditional expression (2).

In the observation optical system 1C according to Example 3, the front optical system 10 does not include a Fresnel lens and a reduction in size is not given much priority. Therefore, neither the conditional expression (1) nor (2) is satisfied.

Table 7 describes basic lens data of the observation optical system 1C according to Example 3. In Table 7, a 0th surface indicates an object plane (a virtual image), a 1st surface indicates the entrance pupil E.P. (having a diameter of 14 mm), a 6th surface indicates the intermediate image 40, and a 14th surface indicates the display panel surface (0.93 inches). In Table 7, R represents a curvature radius of a surface, D represents a surface spacing on an optical axis, Nd represents a refractive index with respect to a d-line, and vd represents an Abbe's number with respect to the d-line. Further, in Table 7, a surface having a surface type of SPH and having an R value of 1e+18 represents a planar surface. REFR represents a refractive surface, and REFL represents the reflection surface 31. Further, in Table 7, “SPH” represents a spherical surface, and “ASP” represents an aspherical surface. An expression for an aspherical surface is similar to that in Example 1. In Table 7, “SPS XYP” represents an XY polynomial surface. An expression for an XY polynomial surface is similar to that in Example 1.

Table 8 describes aspherical coefficients of the observation optical system 1C according to Example 3. Table 9 describes eccentricity data of the observation optical system 1C according to Example 3. The eccentricity data describes coordinates of a surface of interest using a surface immediately before the surface of interest as a reference and Euler angles for each surface.

TABLE 7
Example 3 Lens data

| Surface | | | | | | Reflection, |
|---|---|---|---|---|---|---|
| number | R | D | Nd | νd | Surface type | refraction |
| 0 | 1e+018 | −2500.0000 | 1.000 | | SPH | REFR |
| 1 | 1e+018 | 13.7352 | 1.000 | | SPH | REFR |
| 2 | −558.8367 | 4.4651 | 1.535 | 55.7 | ASP | REFR |
| 3 | −82.3441 | 0.5118 | 1.000 | | ASP | REFR |
| 4 | −58.9472 | 18.1793 | 1.535 | 55.7 | ASP | REFR |
| 5 | −22.0467 | 46.7751 | 1.000 | | ASP | REFR |
| 6 | 1e+018 | 9.6958 | 1.000 | | SPH | REFR |
| 7 | −146.1907 | −88.0710 | 1.000 | | ASP | REFL |
| 8 | 30.9824 | −8.0000 | 1.535 | 55.7 | ASP | REFR |
| 9 | 31.5734 | −7.1216 | 1.000 | | ASP | REFR |
| 10 | −33.1465 | −13.2332 | 1.535 | 55.7 | ASP | REFR |
| 11 | 124.2015 | −19.8536 | 1.000 | | ASP | REFR |
| 12 | 1e+018 | −17.0000 | 1.535 | 55.7 | SPS XYP | REFR |
| 13 | 16.1904 | −8.1761 | 1.000 | | SPS XYP | REFR |
| 14 | 1e+018 | 0.0000 | 1.000 | | SPH | REFR |

TABLE 8
Example 3 Aspherical coefficients

| Surface | | | | |
|---|---|---|---|---|
| number | A | B | C | D |
| 2 | 5.8364e−007 | 0.0000e+000 | 0.0000e+000 | 0.0000e+000 |
| 3 | 5.0053e−006 | −8.4050e−010 | 0.0000e+000 | 0.0000e+000 |
| 4 | 8.8480e−006 | −2.2172e−009 | 0.0000e+000 | 0.0000e+000 |
| 5 | −3.0485e−006 | 3.3809e−009 | 9.7099e−012 | −1.8168e−014 |
| 7 | −1.4683e−007 | 0.0000e+000 | 0.0000e+000 | 0.0000e+000 |
| 8 | 0.0000e+000 | 0.0000e+000 | 0.0000e+000 | 0.0000e+000 |
| 9 | 1.8180e−006 | −5.2419e−009 | 0.0000e+000 | 0.0000e+000 |
| 10 | 6.7629e−006 | −4.7801e−009 | 6.7865e−012 | 0.0000e+000 |
| 11 | −6.3737e−007 | 0.0000e+000 | 0.0000e+000 | 0.0000e+000 |

| Surface | | | |
|---|---|---|---|
| number | E | F | G |
| 2 | 0.0000e+000 | 0.0000e+000 | 0.0000e+000 |
| 3 | 0.0000e+000 | 0.0000e+000 | 0.0000e+000 |
| 4 | 0.0000e+000 | 0.0000e+000 | 0.0000e+000 |
| 5 | −3.9908e−019 | 1.7281e−020 | −5.5600e−024 |
| 7 | 0.0000e+000 | 0.0000e+000 | 0.0000e+000 |
| 8 | 0.0000e+000 | 0.0000e+000 | 0.0000e+000 |
| 9 | 0.0000e+000 | 0.0000e+000 | 0.0000e+000 |
| 10 | 0.0000e+000 | 0.0000e+000 | 0.0000e+000 |
| 11 | 0.0000e+000 | 0.0000e+000 | 0.0000e+000 |

TABLE 9
Example 3 Eccentricity data

| Surface | | | | | | |
|---|---|---|---|---|---|---|
| number | XDE | YDE | ZDE | ADE | BDE | CDE |
| 0 | 0.0000 | 0.0000 | 0.0000 | 0.0000 | 0.0000 | 0.0000 |
| 1 | 0.0000 | 0.0000 | 0.0000 | 0.0000 | 0.0000 | 0.0000 |
| 2 | 0.0000 | −5.4711 | 0.0000 | −0.9859 | −0.0000 | 0.0000 |
| 3 | 0.0000 | 0.0000 | 0.0000 | −0.0000 | −0.0000 | 0.0000 |
| 4 | 0.0000 | 0.0000 | 0.0000 | −0.0000 | −0.0000 | 0.0000 |
| 5 | 0.0000 | 0.0000 | 0.0000 | −0.0000 | −0.0000 | 0.0000 |
| 6 | 0.0000 | 0.0000 | 0.0000 | −0.0000 | −0.0000 | 0.0000 |
| 7 | 0.0000 | −15.3606 | 0.0000 | 10.3850 | −0.0000 | 0.0000 |
| 8 | 0.0000 | −40.1093 | 0.0000 | 57.5295 | −0.0000 | 0.0000 |
| 9 | 0.0000 | 0.0000 | 0.0000 | −0.0000 | −0.0000 | 0.0000 |
| 10 | 0.0000 | 5.6812 | 0.0000 | −38.1395 | 0.0000 | 0.0000 |
| 11 | 0.0000 | 0.0000 | 0.0000 | −0.0000 | −0.0000 | 0.0000 |
| 12 | 0.0000 | 2.2130 | 0.0000 | 21.5552 | 0.0000 | 0.0000 |
| 13 | 0.0000 | 0.0000 | 0.0000 | −0.0000 | −0.0000 | 0.0000 |
| 14 | 0.0000 | 0.0000 | 0.0000 | −8.8365 | −0.0000 | 0.0000 |

Further, coefficients of the XY polynomial surface of the observation optical system 1C according to Example 3 are described below.

### Example 3•Coefficients Cj of XY Polynomial Surface

12th Surface

C3: 7.842e-003
C4: −2.448e-002
C6: −2.941e-002
C8: −5.076e-005
C10: −7.779e-005
C11: 5.136e-008
C13: 6.971e-006
C15: −3.290e-006
C17: 1.537e-006
C19: 6.635e-007
C21: −1.512e-007
C22: 1.169e-007
C24: 5.023e-008
C26: −6.346e-008
C28: −3.025e-008

13th Surface

Cl: −3.589e+000
C3: 1.736e-001
C4: −9.703e-003
C6: −2.240e-002
C8: 3.508e-004
C10: 2.776e-004
C11: −1.040e-005
C13: 3.531e-005
C15: 3.779e-006
C17: 4.526e-007
C19: −1.386e-006
C21: −4.068e-007
C22: 3.216e-007
C24: 1.337e-008
C26: −8.717e-008 C28: 1.114e-008

### 3. Other Embodiments

The technology of the present disclosure is not limited to the description above of the embodiments, and various modifications may be made.

For example, the present technology may have any of the following configurations.

According to the present technology having any of the following configurations, it is possible to achieve both an increase in viewing angle and a reduction in size and weight.

(1)

An observation optical system including:

a reflective optical device that includes at least one reflection surface;

a first lens group that is disposed at a position closer to an entrance pupil than the reflective optical device, the first lens group forming an intermediate image of a virtual image on the reflection surface or at a position closer to the entrance pupil than the reflection surface, the intermediate image of the virtual image corresponding to an image displayed on an image display unit; and

a second lens group that is disposed on an optical path after light passes through the first lens group, the intermediate image, and the reflective optical device in order in a case where ray tracing is performed from an entrance pupil side, the second lens group being disposed to cause an image of the entrance pupil to be formed on an optical path after light is reflected by the reflection surface.

(2)

The observation optical system according to (1) described above, in which the first lens group, the reflective optical device, and the second lens group each have positive power.

(3)

The observation optical system according to (1) or (2) described above, in which a size of the intermediate image is greater than a size of the image displayed on the image display unit.

(4)

The observation optical system according to any one of (1) to (3) described above, in which the reflective optical device and the second lens group are each eccentric and tilted with respect to the first lens group.

(5)

The observation optical system according to any one of (1) to (4) described above, in which the reflective optical device and the second lens group are each eccentric and tilted with respect to the first lens group.

(6)

The observation optical system according to (5) described above, in which at least one of the reflective optical device and the second lens group has a non-axisymmetric free-form surface.

(7)

The observation optical system according to any one of (1) to (6) described above, in which, in a case of being mounted on a head, the observation optical system is configured to allow the image display unit to be disposed closer to an ear side than an eye when viewed from front of a face, and the image display unit to be disposed closer to a face side than the reflection surface of the reflective optical device when viewed from a side of the face.

(8)

The observation optical system according to any one of (1) to (7) described above, in which

1<fb/E<1.25 (1)

is satisfied,

where fb is a focal length of the first lens group, and

E is a length of an eye relief.

(9)

The observation optical system according to any one of (1) to (8) described above, in which

in the case where the ray tracing is performed from the entrance pupil side,

0.55<B/A<0.85 (2)

is satisfied,

where A is an image height of the intermediate image in a vertical direction, and

B is an image height in the vertical direction when the intermediate image is formed on the image display unit with use of the reflective optical device and the second lens group.

(10)

The observation optical system according to any one of (1) to (9) described above, further including:

a light source that emits light to be applied to an eye of a viewer;

a beam splitter that is disposed in an optical path between the first lens group and the reflective optical device, the beam splitter splitting reflected light of the light from the light source reflected by the eye of the viewer;

an imaging optical system that is disposed in an optical path of the reflected light splitted by the beam splitter; and

an imaging device that receives the reflected light via the imaging optical system.

(11)

The observation optical system according to any one of (1) to (10) described above, in which the reflection surface has a semi-transmissive characteristic of transmitting external light.

(12)

An image display apparatus including:

an image display unit; and

an observation optical system that enlarges an image displayed on the image display unit,

the observation optical system including
a reflective optical device that includes at least one reflection surface,
a first lens group that is disposed at a position closer to an entrance pupil than the reflective optical device, the first lens group forming an intermediate image of a virtual image on the reflection surface or at a position closer to the entrance pupil than the reflection surface, the intermediate image of the virtual image corresponding to an image displayed on the image display unit, and
a second lens group that is disposed on an optical path after light passes through the first lens group, the intermediate image, and the reflective optical device in order in a case where ray tracing is performed from an entrance pupil side, the second lens group being disposed to cause an image of the entrance pupil to be formed on an optical path after light is reflected by the reflection surface.

The present application claims priority based on Japanese Patent Application No. 2018-211711 filed with the Japan Patent Office on Nov. 9, 2018 and Japanese Patent Application No. 2019-047459 filed with the Japan Patent Office on Mar. 14, 2019, the entire content of each which is incorporated herein by reference.

It should be understood that those skilled in the art would make various modifications, combinations, sub-combinations, and alterations depending on design requirements and other factors, and they are within the scope of the attached claims or the equivalents thereof.

1. An observation optical system comprising:
a reflective optical device that includes at least one reflection surface;
a first lens group that is disposed at a position closer to an entrance pupil than the reflective optical device, the first lens group forming an intermediate image of a virtual image on the reflection surface or at a position closer to the entrance pupil than the reflection surface, the intermediate image of the virtual image corresponding to an image displayed on an image display unit; and
a second lens group that is disposed on an optical path after light passes through the first lens group, the intermediate image, and the reflective optical device in order in a case where ray tracing is performed from an entrance pupil side, the second lens group being disposed to cause an image of the entrance pupil to be formed on an optical path after light is reflected by the reflection surface.

2. The observation optical system according to claim 1, wherein the first lens group, the reflective optical device, and the second lens group each have positive power.

3. The observation optical system according to claim 1, wherein a size of the intermediate image is greater than a size of the image displayed on the image display unit.

4. The observation optical system according to claim 1, wherein the first lens group is an axisymmetric optical system that includes an axisymmetric lens, the axisymmetric lens having a Fresnel surface.

5. The observation optical system according to claim 1, wherein the reflective optical device and the second lens group are each eccentric and tilted with respect to the first lens group.

6. The observation optical system according to claim 5, wherein at least one of the reflective optical device and the second lens group has a non-axisymmetric free-form surface.

7. The observation optical system according to claim 1, wherein, in a case of being mounted on a head, the observation optical system is configured to allow the image display unit to be disposed closer to an ear side than an eye when viewed from front of a face, and the image display unit to be disposed closer to a face side than the reflection surface of the reflective optical device when viewed from a side of the face.

8. The observation optical system according to claim 1, wherein
1<fb/E<1.25 (1)
is satisfied,
where fb is a focal length of the first lens group, and
E is a length of an eye relief.

9. The observation optical system according to claim 1, wherein
in the case where the ray tracing is performed from the entrance pupil side,
0.55<B/A<0.85 (2)
is satisfied,
where A is an image height of the intermediate image in a vertical direction, and
B is an image height in the vertical direction when the intermediate image is formed on the image display unit with use of the reflective optical device and the second lens group.

10. The observation optical system according to claim 1, further comprising:
a light source that emits light to be applied to an eye of a viewer;
a beam splitter that is disposed in an optical path between the first lens group and the reflective optical device, the beam splitter splitting reflected light of the light from the light source reflected by the eye of the viewer;
an imaging optical system that is disposed in an optical path of the reflected light splitted by the beam splitter; and
an imaging device that receives the reflected light via the imaging optical system.

11. The observation optical system according to claim 1, wherein the reflection surface has a semi-transmissive characteristic of transmitting external light.

12. An image display apparatus comprising:
an image display unit; and
an observation optical system that enlarges an image displayed on the image display unit,
the observation optical system including
a reflective optical device that includes at least one reflection surface,
a first lens group that is disposed at a position closer to an entrance pupil than the reflective optical device, the first lens group forming an intermediate image of a virtual image on the reflection surface or at a position closer to the entrance pupil than the reflection surface, the intermediate image of the virtual image corresponding to an image displayed on the image display unit, and
a second lens group that is disposed on an optical path after light passes through the first lens group, the intermediate image, and the reflective optical device in order in a case where ray tracing is performed from an entrance pupil side, the second lens group being disposed to cause an image of the entrance pupil to be formed on an optical path after light is reflected by the reflection surface.
